(19) United States
(12) Patent Application Publication
(10) Pub. No.: US 2011/0191975 A1
(43) Pub. Date: Aug. 11, 2011

(54) Kitchen spatula

(76) Inventors: Louis F. Genatossio, Shrewsbury, MA (US); Kimberly A. Rada, Johns Island, SC (US)

(21) Appl. No.: 12/658,483

(22) Filed: Feb. 10, 2010

(51) Int. Cl. B05C 17/10

(52) U.S. Cl. 15/245.1

(57) ABSTRACT

A spatula 1 including a head 4 having a top side 6, two spaced longitudinal sides 8,10, front and back planar sides 30, 32 and a bottom end 12, as well as a handle 14 connected to the top end 6 of the head 4. The spatula 1 further includes at least one protrusion 16 extending upwardly from at least a portion of the top end 6 and laterally from near the handle 14 toward one of the longitudinal sides 8, the protrusion 16 contoured to fit the inside of the rim of a container or mixing bowl.

### BACKGROUND OF THE INVENTION

1. Field of the Invention

The invention relates generally to kitchen spatulas. More particularly, the invention relates to spatulas used to obtain ingredients such as condiments, sauces, tomato paste, etc. from containers such as jars, cans, bottles, etc., or to mix ingredients in a mixing bowl.

2. Description of the Prior Art

Spatulas are routinely used in food preparation in home and commercial kitchens. A typical spatula includes a handle and an adjoined blade or head. Spatulas are used for a variety of diverse functions, with the specific functions of a particular spatula dictating the exact shape of the head. For example, spatulas may be used to spread soft foods, such as mayonnaise. Such spatulas typically have a head with at least one curved edge. Other spatulas are used when cooking on a skillet (e.g., flipping pancakes or scrambling eggs). These spatulas have heads with flat front edges for scraping. Still other spatulas may be used to mix ingredients in a mixing bowl. Such mixing spatulas are typically flexible, bending when mixing ingredients and returning to their original shape thereafter.

Prior to some cooking operations, many of the individual ingredients are stored in bottles or jars. Thus, as the ingredients are combined into a bowl to be mixed, each ingredient must first be removed from its jar. Oftentimes the tasks of removing the food from jars and mixing are carried out using the same spatula. The shape of the spatula, however, often precludes the spatula from removing all of the ingredient in the jar. For example, many jars have curved rims connecting the jar opening to the inside walls of the jar. Many spatulas have straight handles connected to straight heads. This straight shape precludes the spatula from removing ingredients from under the rim of the jar.

Prior art spatulas for removing materials from the inside of jars include U.S. Pat. No. 7,182,377, which discloses a spatula with an offset handle that allows the spatula head to make flush contact with the inside walls of a jar. While this spatula attempts to provide improvements over existing spatulas, problems still remain. In particular, the head is incapable of removing ingredients under the rim of a jar because, the portion of the handle directly adjacent the head is straight. Thus, when the head is positioned at the top of the jar, near the rim, the offset portion of the handle is positioned outside the jar and the spatula performs the same way as any other spatula.

### Identification of Objects of the Invention

A primary object of the invention is to provide a spatula that overcomes the disadvantages of the prior art.

Another object of the invention is to provide a spatula capable of scraping material from under the rim of a jar.

Another object of the invention is to provide a spatula with a head having a rounded longitudinal side for scraping curved surfaces and a sharp longitudinal side for scraping straight surfaces.

Another object of the invention is to provide a spatula having a continuous transition from the head to the handle.

Still another object of the invention is to provide a spatula made of a material that can absorb impact forces when the spatula comes into contact with cookware in order to protect the cookware.

### SUMMARY OF THE INVENTION

The objects identified above along with other features and advantages of the invention are incorporated in a spatula having a head with a protrusion extending upwardly from a top lateral corner thereof. The protrusion is shaped to conform to the rims of jars, mixing bowls, or other containers and is usable for removing material from under the rims of jars by positioning the protrusion under a rim and scraping the inside surface thereof. In another embodiment, the protrusion is configured to scrape excess material from the rim of a mixing bowl.

Another aspect of the spatula includes a head having dual use longitudinal sides. One longitudinal side of the head has a rounded cross-section, useful for scraping curved surfaces. The other longitudinal side of the head has a V-shaped cross-section, useful for scraping straight surfaces, especially two surfaces that intersect forming a corner such as found in certain square baking pans and the like. Similarly, the spatula head includes a dual option bottom end. One side of the bottom end culminates in a rounded corner for scraping rounded surfaces, such as mixing bowls. The other side of the bottom end culminates in the V-shaped cross-section of the longitudinal side for scraping intersecting surfaces, such as corners of cake pans and casserole dishes.

Yet another aspect of the spatula includes a continuous transition between the handle and the head of the spatula. The shape of the handle corresponds to the shape of the spatula head at the interface therebetween, such that the profile of the combined components is continuous. In addition, the portion of the head that connects to the handle is made of silicone. The silicone spatula head includes a length of silicone material which extends into a cylindrical end of the handle. An advantage of the silicone construction is that silicone is soft enough to absorb impact forces when the spatula head strikes a piece of cookware. The end of the handle with silicone inserted in its end is somewhat compliant so that a blow to the handle end against a bowl rim or the like is less damaging to the bowl. Thus, the banging of the spatula against enameled cookware, in order to remove batter or the like from the blade of the spatula, will not as likely damage or dent the enamel of the cookware as compared to banging with a solid wood handle of a spatula.

### BRIEF DESCRIPTION OF THE DRAWINGS

The invention will be better understood by referring to the detailed description of embodiments below and by examining the accompanying drawings, in which:

FIG. 1 is a perspective view of a spatula according to the invention;

FIG. 2 is a front view of a spatula according to the invention;

FIG. 3 is a cross-sectional view of the head of the spatula according to the invention taken along lines 3-3 of FIG. 1;

FIG. 4 is a side view of the spatula according to the invention;

FIG. 5 is a side view of the side of the spatula opposite that shown in FIG. 4;

FIG. 6 is a front view of a spatula head of another embodiment of the present invention;

FIG. 7 is a front view of a spatula head of yet another embodiment of the present invention; and

FIG. 8 is a front view of a spatula head of still another embodiment of the present invention.

### DESCRIPTION OF A PREFERRED EMBODIMENT OF THE INVENTION

The aspects, features, and advantages of the invention mentioned above are described in more detail by reference to the drawings wherein like reference numerals represent like elements.

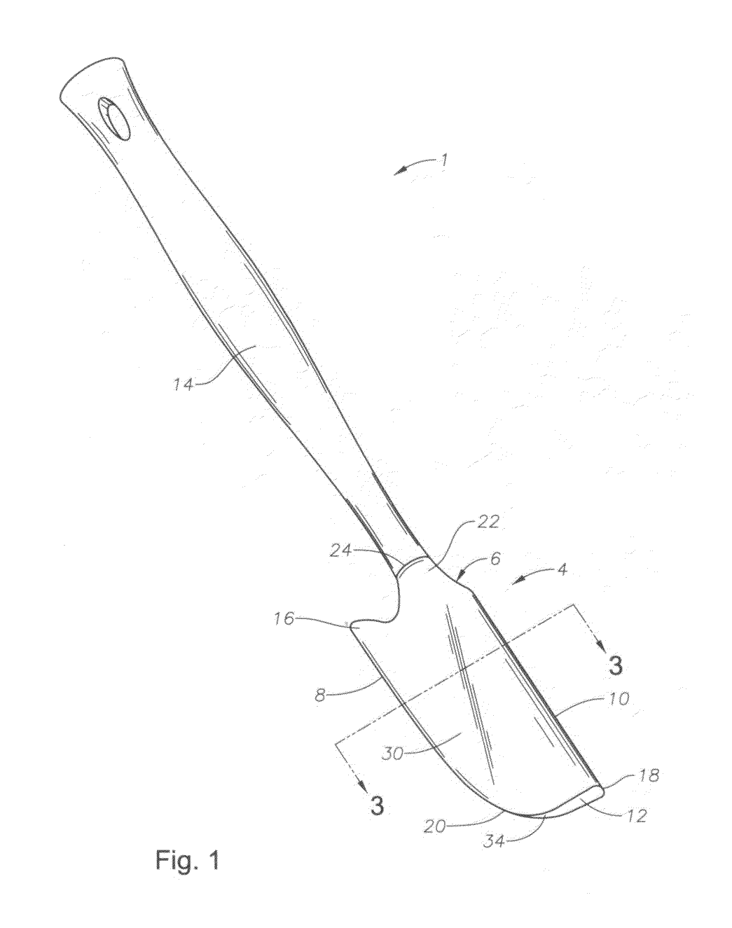

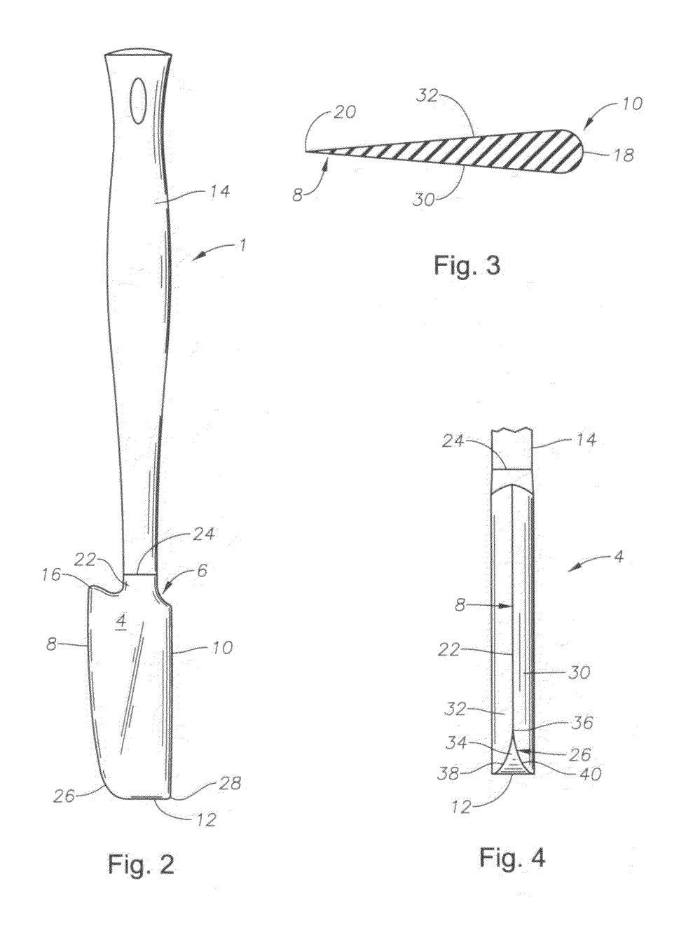

FIG. 1 shows a perspective view of a spatula 1 that embodies the invention. The spatula 1 has a head 4 and a handle 14. The head 4 has a top end 6, two longitudinal sides 8, 10, front and back sides 30, 32 and a bottom end 12. The head 4 also has a rim swipe portion 16 and a handle-receiving portion 22 at the top end 6. As illustrated in FIG. 2, the shape of the interface 26 between longitudinal side 8 and the bottom end 12 is curved. Conversely, the shape of the interface 28 between longitudinal side 10 and the bottom end 12 is substantially square in shape. In addition, as shown in FIGS. 1 and 3, one longitudinal side 10 of the head 4 is rounded, while the other longitudinal side 8 is V-shaped. Furthermore, the interface 24 between the handle 14 and the handle-receiving portion 22 is continuous. The handle-receiving portion 22 is made of silicone or other soft material thereby providing a softer strike zone for enameled or glass baking or cookware when a user strikes the spatula on the cookware in order to remove batter or other material from the spatula.

The rim swipe portion 16 of the spatula head 4, as shown in FIGS. 1 and 2, is a projection rising upwardly from the top end 6 and extending laterally from the handle-receiving portion 22 to the V-shaped longitudinal side 8 of the spatula head 4. The rim swipe 16 is shaped to reach under top inside rims of jars and bottles when the spatula head is extends into the mouth or opening of the jars and bottles. Such shape enables a user to scrape the contents out from under the rim of a jar or bottle by scraping the rim swipe 16 around and upwardly of the inside surface of the jar or bottle rim. This feature enables a user to reduce food waste, because food material will be saved and used that would otherwise be stuck under the rim of a jar or bottle and disposed of. In addition, the rim swipe portion 16 of spatula head 4 saves time and increases efficiency by enabling a cook to remove food material from under a jar rim without the use of additional tools or techniques.

Also shown in FIG. 2 are the curved interface portion 26 and squared interface portion 28 between the longitudinal sides 8, 10 and the bottom end 12 of spatula head 4. The different shapes of interfaces 26 and 28 creates a dual option bottom end 12, where each side of the bottom end 12 is configured to scrape cookware having a differing geometry. For example, the curved interface surface 26 allows a user to scrape the rounded contours of mixing bowls, but the squared interface surface 28 allows scraping of the square corners of cake pans, casserole dishes, and the like.

FIG. 3 shows a cross-sectional view taken along lines 3-3 of FIG. 1 of a spatula head 4 and, in particular, the rounded shape 18 of longitudinal side 10 and the V-shape 20 of longitudinal side 8. The front 30 and back sides 32 of the spatula head 4 are smooth and taper outwardly from V-shaped longitudinal side 8 to rounded longitudinal side 10. The different shapes of V-shape 20 edge of longitudinal side 8 and rounded shape 18 of longitudinal side 10 of the spatula head 4 permit the spatula 1 to be used to effectively scrape a variety of cooking surfaces having differing shapes. For example, the rounded longitudinal side 10 serves well to scrape curved surfaces, while the V-shaped longitudinal side 8 serves to scrape straight surfaces. In addition, the smooth flat surfaces of the front side 30 and back side 32 of the head 4 permit easy removal of batter or cooking ingredients from those surfaces by scraping them along the edge of a mixing bowl.

The handle-receiving portion 22 of the spatula 1 is manufactured of an impact resistant material, such as silicone thereby providing a strike zone. The silicone spatula head 22 includes a length of silicone material which extends into a cylindrical end of the handle. When a user strikes the portion 22 of the spatula 1 against a cookware bowl, for example, to remove food from the head 4 of the spatula 1, the impact of the strike is absorbed by the handle-receiving portion 22, thereby protecting the cookware and the spatula 1 from damage. The handle-receiving portion 22 generally extends upwardly beyond the top end 6 of the spatula head 4 in order to provide a larger strike zone. The end of the handle with silicone inserted in its end is somewhat compliant so that a blow to the handle end against a bowl rim or the like is less damaging to the bowl. Furthermore, as can be seen in each of FIGS. 1-2 and 4-5, the shape of the handle-receiving portion 22 of the head 4 matches the shape of the handle 14 at the interface 24 where they intersect, such that the transition between the handle-receiving portion 22 and the handle 14 is continuous.

FIG. 4 shows a side view of the spatula 1, including the V-shaped longitudinal side 8, as well as front 30 and back 32 as they taper outwardly away from longitudinal side 8. FIG. 4 also shows the shape of the interface 26 between the longitudinal side 8 and the bottom end 12. The front and back surfaces 30, 32 of the spatula head 4 curve at the interface between longitudinal side 8 and bottom end 12. In addition, transition surface 34 connects longitudinal side 8 to bottom end 12. Transition surface 34 has an apex 36, located at the lowermost point where the front side 30 and back side 32 of the spatula head 4 come into direct contact with one another along V-shaped longitudinal side 8. From apex 36, longitudinal sides 38, 40 of transition surface 34 extend downwardly toward the bottom end 12, taper laterally toward the front surface 30 and back surface 32, and curve inwardly from the V-shaped longitudinal side 8 toward the center of the spatula head 4.

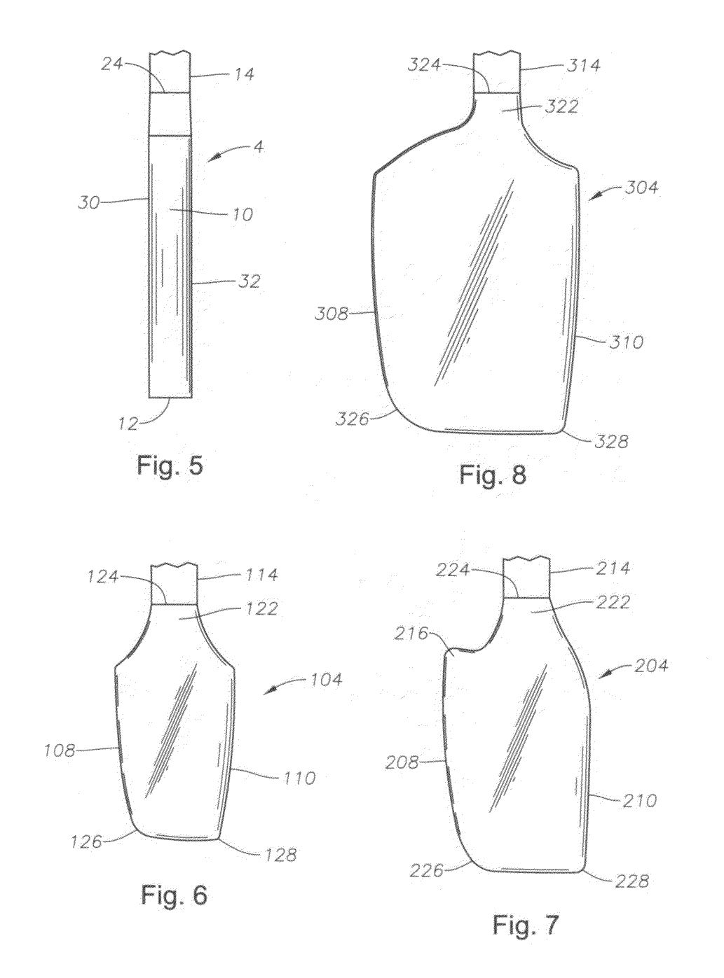

FIG. 5 is a side view of the spatula head 4 showing rounded side 10. The interface between rounded longitudinal side 10 and the bottom end 12 is square shaped.

FIGS. 6-8 show spatula heads of alternative embodiments of the invention. FIG. 6, for example, shows a spatula head 104 that is laterally broader than the spatula head 4 of the embodiment shown in FIGS. 1-5. The spatula head 104 has rim swipe regions on both longitudinal sides below the handle-receiving portion 122. These rim swipe regions are different from that of FIGS. 1 and 2 in that they are designed to scrape the outer rim of a mixing bowl after ingredients/batter has been poured from the bowl. As in the previous embodiment, the interface 124 between a handle-receiving portion 122 and handle 114 is continuous. In addition, the spatula head 104 includes a rounded side 110, a V-shaped longitudinal side 108, a curved front corner 126 and a squared front corner 128 at its bottom end with the handle-receiving portion 122 serving also as a strike zone. Each of these features is structurally similar and carries out the same functions as the corresponding features of the embodiment of FIGS. 1-5 discussed above.

The spatula head 204 of FIG. 7 is likewise similar to that discussed above with regard to the embodiment of FIGS. 1-5 and includes the same features, including a rim swipe 216, a continuous transition 224 between a handle-receiving portion 222 and a handle 214, a V-shaped longitudinal side 208, a rounded side 210, a curved front corner 226, a squared front corner 228, with the handle-receiving portion 222, serving also as a strike zone. The spatula head 204 differs from the embodiments described above in that it is larger. The rim swipe 216 is configured to wipe the rims of mixing bowls or other cookware, containers, etc.

The spatula head 304 of FIG. 8 is similar to that of the preceding embodiments, having a continuous transition 324 between a handle-receiving portion 322 and a handle 314, a V-shaped longitudinal side 308, a rounded longitudinal side 310, a bottom end with a curved front corner 326, a squared front corner 328, and a strike zone. The areas on the longitudinal sides immediately below handle-receiving portion 222 serve as rim swipe regions. Like the rim swipe regions of FIG. 6, the rim swipe regions of FIG. 8 are designed to scrape the outer rim of a mixing bowl once ingredients/batter has been poured from it. The spatula head 304 is larger than the spatula heads of any of the other embodiments herein disclosed.

What is claimed is:

1. A spatula (1), comprising:
a head (4) having a top end (6), two spaced longitudinal sides (8,10), and a bottom end (12);
a handle (14) connected to the top end (6) of the head (4);
at least one protrusion (16) extending upwardly of at least a portion of the top end (6) and laterally from near the handle (14) toward one of the longitudinal sides (8, 10), the protrusion (16) arranged and designed to conform to the inside of a rim of a container or mixing bowl;
wherein one longitudinal side (10) terminates in a rounded shape (18), and the other longitudinal side (8) terminates in V-shape (20).

2. The spatula (1) of claim 1, wherein
the head (4) has a smooth planar front side (30) and a smooth planar back side (32), the front side (30) and back side (32) each extending from one longitudinal side (8) to the other longitudinal side (10).

3. The spatula (1) of claim 1, wherein
the head (4) includes a handle-receiving portion (22) attached to the top end (6) of the head (4), the handle-receiving portion (22) having a cross-sectional shape that matches a cross-sectional shape of the handle (14), such that an outer interface (24) between the handle-receiving portion (22) and the handle (14) is continuous.

4. The spatula (1) of claim 3, wherein
the handle-receiving portion (22) is made of silicone, thereby creating a softer strike zone for enameled or glass baking or cookware when the spatula (1) strikes the edge of the baking or cookware.

5. The spatula (1) of claim 2, wherein
an interface (26) between said one longitudinal side (8) and said bottom end (12) is curved, and
an interface (28) between the other longitudinal side (10) and the bottom end (12) is squared.

6. The spatula (1) of claim 5, wherein
the interface (26) between the longitudinal side (8) and the bottom end (12) includes a transition surface (34) having an apex (36) at the bottom end of longitudinal side (8) and bounded by transition edges (38, 40) extending from the apex (36) downwardly toward the bottom end (12), laterally toward said front side (30) and said back side (32), and inwardly toward longitudinal side (10).

7. A spatula (1), comprising:
a head (4) having two spaced longitudinal sides (8,10), a bottom end (12), a top end (6), and a longitudinally extending handle-receiving portion (22) protruding from the top end (6);
a handle (14) connected to the handle-receiving portion (22); and
at least one protrusion (16) positioned laterally of the handle-receiving portion (22) and extending upwardly from the top end (6) and laterally from near the handle (14) toward one of the longitudinal sides (8), the protrusion (16) contoured to fit the inside of the rim of a container or mixing bowl;
wherein the handle-receiving portion (22) has a cross-sectional shape that matches a cross-sectional shape of the handle (14), such that the interface (24) between the handle-receiving portion (22) and the handle (14) is continuous.

8. The spatula (1) of claim 7, wherein
the head (4) has a smooth planar front side (30) and a smooth planar back side (32), the front side (30) and back side (32) each extending from one longitudinal side (8) to the other longitudinal side (10).

9. The spatula (1) of claim 7, wherein
one longitudinal side (10) has a rounded cross-section (18) and the other longitudinal side (8) has a V-shaped cross-section (20).

10. The spatula (1) of claim 7, wherein
the handle-receiving portion (22) is made of silicone, thereby creating a strike zone for protecting cookware when the spatula (1) strikes the cookware in order to remove food material from the head (4).

11. The spatula (1) of claim 8, wherein
a first front profile of an interface (26) between one longitudinal side (8) and the bottom end (12) is of curved shape and a second front profile of the interface (28) between the other longitudinal side (10) and the bottom end (12) is of square shape.

12. The spatula (1) of claim 11, wherein
the interface (26) between the longitudinal side (8) and the bottom end (12) includes a transition surface (34) having an apex (36) at the bottom end of longitudinal side (8) and bounded by transition edges (38, 40) extending from the apex (36) downwardly toward bottom end (12), laterally toward front planar side (30) and back planar side (32), and inwardly toward longitudinal side (10).

13. A sptula (1), comprising:
a head portion (4) having a top end (6), two spaced longitudinal sides (8,10), and a bottom end (12);
a handle-receiving portion (22) integrally formed with the head portion (4) and extending from the top end (6) thereof; and
a handle portion (14);
said one longitudinal side (10) having a rounded cross-section (18) and the other longitudinal side (8) having a V-shaped cross-section (20); and
said handle-receiving portion (22) having a cross-sectional shape that matches a cross-sectional shape of the handle portion (14); such that an interface (24) between the handle-receiving portion (22) and the handle portion (14) is continuous.

14. The spatula (1) of claim 13, further comprising
at least one protrusion (16) positioned laterally of the handle-receiving portion (22) and extending upwardly from the top end (6) and laterally from near the handle portion (14) toward one of the longitudinal sides (8, 10), the protrusion (16) shaped to fit the inside of the rim of a container or mixing bowl.

15. The spatula (1) of claim 13, wherein
the head portion (4) has a smooth planar front side (30) and a smooth planar back side (32), the front side (30) and back side (32) each extending from one longitudinal side (8) to the other longitudinal side (10).

16. The spatula (1) of claim 13, wherein
the handle-receiving portion (22) is made of silicone, thereby creating a strike zone for protecting cookware when the spatula (1) impacts the cookware.

17. The spatula (1) of claim 16 wherein a length of said handle-receiving silicone portion (22) extends into an opening at the end of said handle (14).

18. The spatula (1) of claim 15, wherein
the front profile of the interface (26) between one longitudinal side (8) and the bottom (12) is of curved shape and the front profile of the interface (28) between the other longitudinal side (10) and the bottom end (12) is of square shape.

19. The spatula (1) of claim 17, wherein
the interface (26) between the longitudinal side (8) and the bottom end (12) includes a transition surface (34) having an apex (36) at the bottom of side (8) and bounded by transition edges (38, 40) extending from the apex (36) downwardly toward bottom end (12), laterally toward front planar side (30) and back planar side (32), and inwardly toward longitudinal side (10).
